(19) United States
(12) Patent Application Publication
(10) Pub. No.: US 2024/0146468 A1
(43) Pub. Date: May 2, 2024

(54) METHOD, DEVICE AND COMPUTER STORAGE MEDIUM OF COMMUNICATION

(71) Applicant: NEC CORPORATION, Tokyo (JP)

(72) Inventors: Gang WANG, Beijing (CN); Lin LIANG, Beijing (CN)

(73) Assignee: NEC CORPORATION, Tokyo (JP)

(21) Appl. No.: 18/280,738

(22) PCT Filed: Mar. 16, 2021
(86) PCT No.: PCT/CN2021/081144

§ 371 Date: Sep. 7, 2023

(51) Int. Cl. H04L 1/1829; H04W 72/232

(52) U.S. Cl. CPC H04L 1/1864; H04L 1/1861; H04W 72/232

(57) ABSTRACT

Embodiments of the present disclosure relate to methods, devices and computer readable media for communication. A terminal device receives, from a network device, a first downlink transmission on a first cell in a cell group; and determines, from a set of cells for uplink control transmissions associated with the cell group, a second cell for a first uplink control transmission for a first HARQ feedback for the first downlink transmission. In this way, a latency for HARQ feedback can be reduced.

### TECHNICAL FIELD

Embodiments of the present disclosure generally relate to the field of telecommunication, and in particular, to methods, devices and computer storage media of communication for hybrid automatic repeat request (HARQ) feedback.

### BACKGROUND

In new radio (NR) Release 16, for a terminal device configured with carrier aggregation (CA), only an uplink (UL) carrier of a component carrier (CC) is configured to transmit a physical uplink control channel (PUCCH) for HARQ feedback within a cell group, also called PUCCH group, e.g., primary cell.

In NR Release 17, in order to reduce a latency of HARQ feedback for downlink (DL) heavy configurations in unpaired spectrum, PUCCH carrier switching for HARQ feedback is proposed to allow more than one UL carrier with different time division duplexing (TDD) configurations for PUCCH transmission for HARQ feedback. However, implementations for the PUCCH carrier switching are incomplete, possibly resulting in undesired latency of HARQ feedback.

### SUMMARY

In general, embodiments of the present disclosure provide methods, devices and computer storage media of communication for HARQ feedback.

In a first aspect, there is provided a method of communication. The method comprises: receiving, at a terminal device and from a network device, a first downlink transmission on a first cell in a cell group; and determining, from a set of cells for uplink control transmissions associated with the cell group, a second cell for a first uplink control transmission for a first HARQ feedback for the first downlink transmission.

In a second aspect, there is provided a method of communication. The method comprises: transmitting, at a network device and to a terminal device, a first downlink transmission on a first cell in a cell group; and receiving, from the terminal device, a first HARQ feedback for the first downlink transmission on a second cell, the second cell being determined from a set of cells for uplink control transmissions associated with the cell group.

In a third aspect, there is provided a terminal device. The terminal device comprises a processor configured to perform the method according to the first aspect of the present disclosure.

In a fourth aspect, there is provided a network device. The network device comprises a processor configured to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2A illustrates a schematic diagram illustrating an example scenario for HARQ feedback according to conventional solutions;

FIG. 2B illustrates a schematic diagram illustrating an example scenario of a PUCCH carrier switching for HARQ feedback according to embodiments of the present disclosure;

FIG. 3A illustrates a flow chart illustrating a process of communication for HARQ feedback according to embodiments of the present disclosure;

FIG. 3B illustrates a flow chart illustrating another process of communication for HARQ feedback according to embodiments of the present disclosure;

FIG. 3C illustrates a flow chart illustrating another process of communication for HARQ feedback according to embodiments of the present disclosure;

FIG. 3D illustrates a flow chart illustrating another process of communication for HARQ feedback according to embodiments of the present disclosure;

FIG. 4 illustrates a schematic diagram illustrating an example configuration for PUCCH carriers according to embodiments of the present disclosure;

FIG. 5A illustrates a schematic diagram illustrating an example of a PUCCH carrier switching for semi-persistent scheduling (SPS) HARQ-acknowledgement (HARQ-ACK) according to embodiments of the present disclosure;

FIG. 5B illustrates a schematic diagram illustrating another example of a PUCCH carrier switching for SPS HARQ-ACK according to embodiments of the present disclosure;

FIG. 6 illustrates a schematic diagram illustrating an example of an interaction between a PUCCH carrier switching for SPS HARQ-ACK and a SPS HARQ-ACK deferral according to embodiments of the present disclosure;

FIG. 7A illustrates a schematic diagram illustrating an example for an interaction between a PUCCH carrier switching and an intra-UE multiplexing or prioritization according to embodiments of the present disclosure;

FIG. 7B illustrates a schematic diagram illustrating an example scenario of the interaction between the PUCCH carrier switching and the intra-UE multiplexing according to embodiments of the present disclosure;

FIG. 8 illustrates an example method of communication implemented at a terminal device in accordance with some embodiments of the present disclosure;

FIG. 9 illustrates an example method of communication implemented at a network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, in NR Release 17, in order to reduce the latency of HARQ feedback for DL heavy configurations in unpaired spectrum, PUCCH carrier switching for HARQ feedback is proposed to allow more than one UL carrier or cell with different TDD configurations for PUCCH transmission for HARQ feedback. However, how to implement the PUCCH carrier switching needs to be studied, for example, how to enable or disable the PUCCH carrier switching, how to implement the PUCCH carrier switching for SPS HARQ-ACK, how to handle an interaction between the PUCCH carrier switching for SPS HARQ-ACK and a SPS HARQ-ACK deferral, or how to handle an interaction between the PUCCH carrier switching and an intra-UE multiplexing or prioritization.

In view of this, embodiments of the present disclosure provide a solution for solving the above issues or potential issues in PUCCH carrier switching. In the solution, for a cell group provided by a network device to a terminal device, a set of cells is configured for PUCCH transmission for HARQ feedback of downlink transmissions on cells in the cell group. Upon receipt of a downlink transmission on a cell (for convenience, also referred to as a first cell herein) in the cell group from the network device, the terminal device can determine, from the set of cells, a cell (for convenience, also referred to as a second cell herein) for PUCCH transmission for HARQ feedback for the downlink transmission. In this way, PUCCH carrier switching can be flexibly done among the set of cells as needed, and a latency for HARQ feedback can be significantly reduced.

Embodiments of the present disclosure may be applied to any suitable scenarios. For example, embodiments of the present disclosure may be implemented at ultra-reliable low latency communication (URLLC). Alternatively, embodiments of the present disclosure can be implemented in one of the followings: reduced capability NR devices, NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

Principles and implementations of the present disclosure will be described in detail below with reference to the figures.

### Example of Communication Network

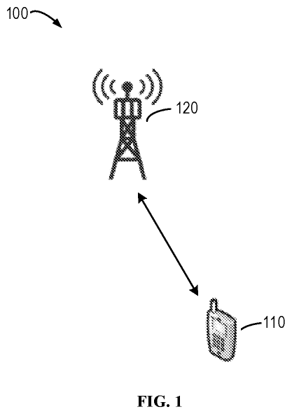

FIG. 1 illustrates a schematic diagram of an example communication network 100 in which some embodiments of the present disclosure can be implemented. As shown in FIG. 1, the communication network 100 may include a terminal device 110 and a network device 120. In some embodiments, the terminal device 110 may be served by the network device 120. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

As shown in FIG. 1, the terminal device 110 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5Gs 2.75Q the third generation (3G), the fourth generation (4G), 4.5G; the fifth generation (5G) communication protocols.

In some embodiments, the terminal device 110 may transmit uplink data to the network device 120 via an uplink data channel transmission. For example, the uplink data channel transmission may be a physical uplink shared channel (PUSCH) transmission. Of course, any other suitable forms are also feasible.

In some embodiments, the terminal device 110 may transmit uplink control information (UCI), e.g., HARQ feedback information to the network device 120 via an uplink control channel transmission. For example, the uplink control channel transmission may be a PUCCH transmission. Of course, any other suitable forms are also feasible.

In some embodiments, the network device 120 may support a plurality of services have different priorities for the terminal device 110, for example, eMBB with a lower priority and URLLC with a higher priority. Accordingly, the terminal device 110 may perform respective uplink data and/or control channel transmissions for the different services. The uplink control channel transmissions may carry HARQ feedbacks for different services and the HARQ feedbacks may have different priorities corresponding to different services.

In some embodiments, the network device 120 may provide a plurality of serving cells (not shown herein) for the terminal device 110, for example, a primary cell (Pcell), a primary secondary cell (PScell), a secondary cell (Scell), a special cell (sPCell) or the like. Each of the serving cells may correspond to a CC. The terminal device 110 may perform transmission with the network device 120 via a CC. Of course, the terminal device 110 may perform transmission with the network device 120 via multiple CCs, for example, in case of CA.

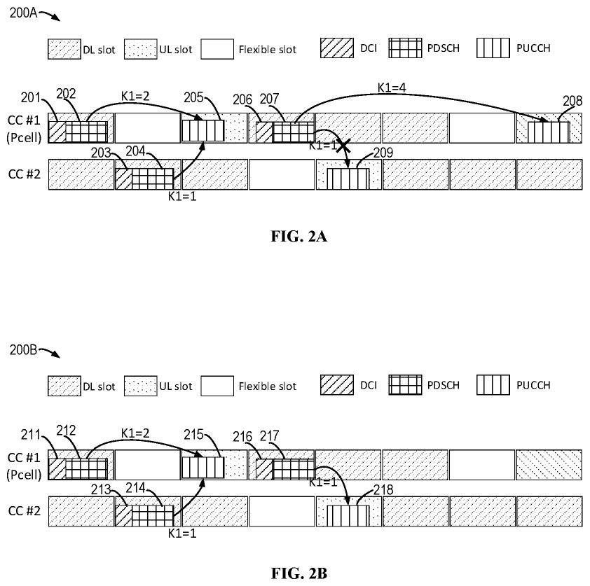

In some scenarios, a cell group is provided by the network device 120 to the terminal device 110. According to conventional solutions, only one cell within the cell group is configured with UL carrier for PUCCH transmission for HARQ-ACK of PDSCH receptions on all cells in the cell group, the cell group is also called PUCCH group. FIG. 2A illustrates a schematic diagram 200A illustrating an example scenario for HARQ feedback according to conventional solutions. In this example, a cell group provided by a network device to a terminal device comprises CC #1 and CC #2, and CC #1 as a Pcell is configured for PUCCH transmission for HARQ feedback for the cell group.

As shown in FIG. 2A, DCI 201 may indicate that a HARQ feedback for PDSCH 202 is transmitted by PUCCH 205 on CC #1, for example, with a HARQ-ACK timing value K1=2. DCI 203 may indicate that a HARQ feedback for PDSCH 204 is also transmitted by PUCCH 205, for example, with a HARQ-ACK timing value K1=1. DCI 206 may indicate that a HARQ feedback for PDSCH 207 is transmitted by PUCCH 208 on CC #1, for example, with a HARQ-ACK timing value K1=4. However, there is an UL slot on CC #2 can be used for PUCCH 209, which is earlier than the PUCCH 208 on CC #1. According to conventional solutions, the HARQ feedback for the PDSCH 207 cannot be scheduled to be transmitted by the PUCCH 209 as only CC #1 is configured for PUCCH transmission for the cell group, so the low latency requirement for URLLC service may not be satisfied.

According to embodiments of the present disclosure, at least one cell within the cell group is configured with UL carrier for PUCCH transmission for HARQ-ACK of PDSCH receptions on all cells in the cell group. In this case, PUCCH transmission for HARQ feedback can be performed on a cell with early available UL symbols within the at least one cell. FIG. 2B illustrates a schematic diagram 200B illustrating an example scenario of a PUCCH carrier switching for HARQ feedback according to embodiments of the present disclosure. In this example, the cell group provided by the network device 120 to the terminal device 110 may comprise CC #1 and CC #2, and CC #1 as a Pcell and CC #2 as a Scell are both configured for HARQ feedback for the cell group. It is to be understood that this is merely an example, and any other suitable numbers of CCs are also feasible.

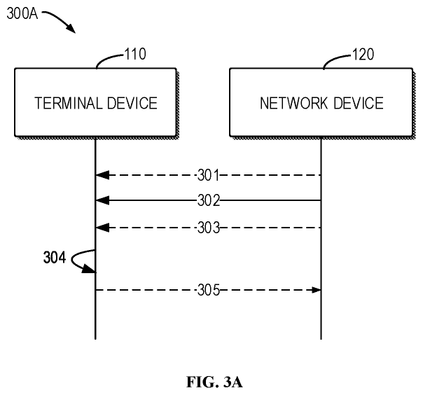

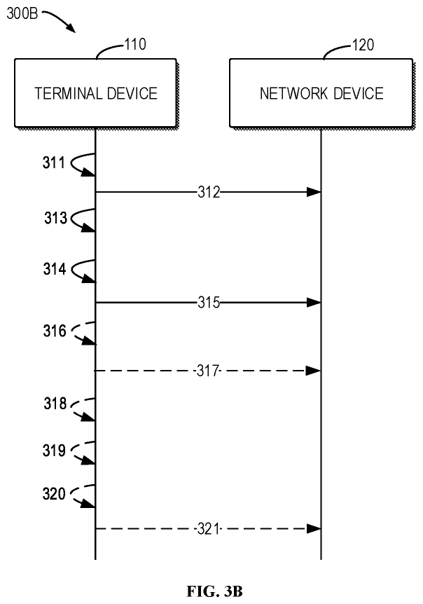

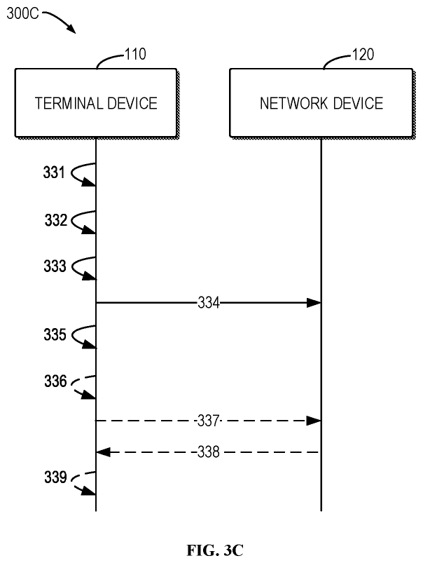

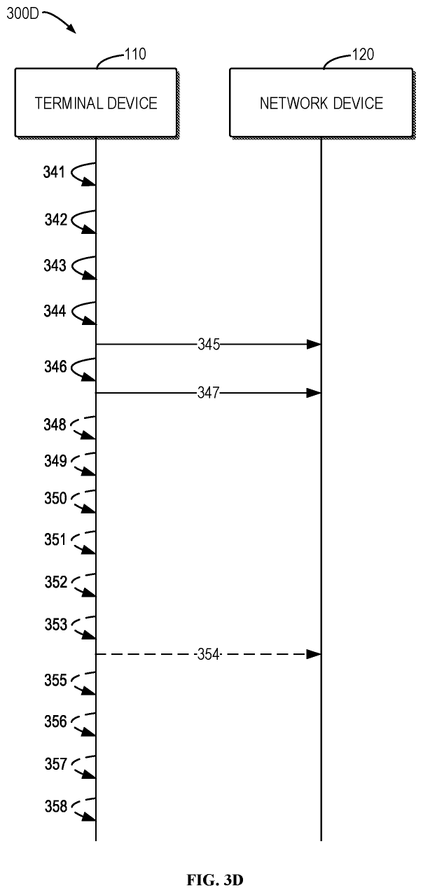

As shown in FIG. 2B, DCI 211 may indicate that a HARQ feedback for PDSCH 212 is transmitted by PUCCH 215 that is early available on CC #1, for example, with a HARQ-ACK timing value K1=2. DCI 213 may indicate that a HARQ feedback for PDSCH 214 is also transmitted by PUCCH 215 that is also early available for PDSCH 214, for example, with a HARQ-ACK timing value K1=1. DCI 216 may indicate that a HARQ feedback for PDSCH 217 is transmitted by PUCCH 218 on CC #2 that is early available for PDSCH 217, for example, with a HARQ-ACK timing value K1=1. In this way, a lower latency of HARQ feedback can be achieved. More details will be described below with reference to FIGS. 3A to 7.

### Example Implementation of Enabling or Disabing Pucch Carrier Switching

FIG. 3A illustrates a flow chart illustrating a process 300A of communication for HARQ feedback according to embodiments of the present disclosure. For the purpose of discussion, the process 300A will be described with reference to FIG. 1. The process 300A may involve the terminal device 110 and the network device 120 as illustrated in FIG. 1.

As shown in FIG. 3A, the network device 120 may transmit 301, to the terminal device 110, a configuration regarding a set of cells (for convenience, also referred to as a set of PUCCH cells herein) for uplink control transmissions (for example, PUCCH transmissions) for HARQ feedbacks for downlink transmissions (for example, PDSCH or PDCCH transmissions) on cells within a cell group. In some embodiments, the cell group comprises a plurality of cells provided by the network device 120 to the terminal device 110. In some embodiments, the set of cells is selected from the plurality of cells in the cell group. In some embodiments, cells different from the cells in the cell group may be configured in the set of cells.

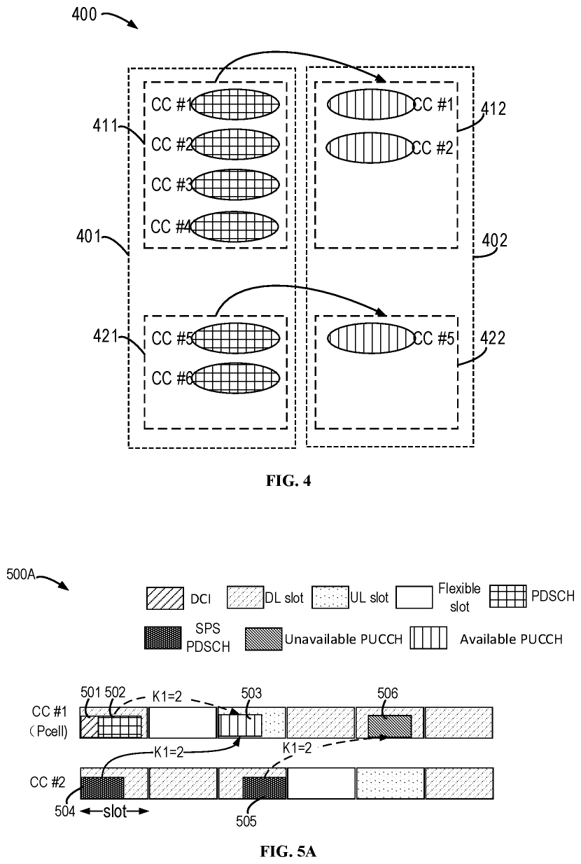

In some embodiments, the set of cells may comprise multiple PUCCH cells associated with the same cell group, i.e., multiple cells for PUCCH transmission are configured within a PUCCH group. This will be detailed with reference to FIG. 4. FIG. 4 illustrates a schematic diagram 400 illustrating an example configuration for PUCCH carriers according to embodiments of the present disclosure. As shown in FIG. 4, the network device 120 may configure a cell group 401 to the terminal device 110 for CA, and configure a set of cells 402 for PUCCH transmission of HARQ feedback for the cell group 401. The cell group 401 comprises CC #1 to CC #6, and the set of cells 402 comprises CC #1, CC #2 and CC #5. It should be noted that the number of cells in the cell group, the number of cell groups, and the number of PUCCH cells in the set of PUCCH cells are merely for illustration and are not for limitation.

In some embodiments, the cell group may comprise a first subgroup of cells and a second subgroup of cells, and the set of cells may comprise a first set of PUCCH cells (also referred to as a first subset of cells herein) associated with the first subgroup of cells and a second set of PUCCH cells (also referred to as a second subset of cells herein) associated with the second subgroup of cells. Still with reference to FIG. 4, a cell subgroup 411 comprising CC #1, CC #2, CC #3 and CC #4 and a cell subgroup 421 comprising CC #5 and CC #6 may be provided for the terminal device 110. In this embodiment, a set of PUCCH cells 412 is configured for the cell subgroup 411 and a set of PUCCH cells 422 is configured for the cell subgroup 412. The set of PUCCH cells 412 comprises CC #1 and CC #2, and the set of PUCCH cells 422 comprises CC #5. It should be noted that the number of cells in the cell subgroup, the number of cell subgroups, and the number of PUCCH cells in the set of PUCCH cells are merely for illustration and are not for limitation. In this embodiment, the cell subgroup is associated with the corresponding set of PUCCH cells, and thus is also referred to as a PUCCH group. For example, the cell subgroup 411 may be a primary PUCCH group, and the cell subgroup 421 may be a secondary PUCCH group.

In some scenarios, the network device 120 transmits 302 a downlink transmission (for convenience, also referred to as a first downlink transmission herein) to the terminal device 110. In some embodiments, the downlink transmission may be a SPS downlink data transmission such as a SPS PDSCH transmission. Of course, the downlink transmission may be a dynamically scheduled downlink data transmission. In some embodiments, the downlink transmission may be downlink control transmission such as a PDCCH transmission for SPS release requiring a HARQ feedback.

In some embodiments, the network device 120 may transmit 303 a configuration indicating whether an uplink control transmission (for convenience, also referred to as a first uplink control transmission herein) for a HARQ feedback (for convenience, also referred to as a first HARQ feedback herein) for the downlink transmission is enabled to change from being performed on a source cell in the set of cells to being performed on a target cell in the set of cells. In other words, the configuration indicates whether the PUCCH carrier switching is enabled or disabled. In some embodiments, the configuration may indicate that the PUCCH carrier switching is enabled. In some alternative embodiments, the configuration may indicate that the PUCCH carrier switching is disabled. In this way, a signaling to enable the PUCCH carrier switching can be designed, and latency can be reduced.

In some embodiments, the network device 120 may transmit the configuration regarding the PUCCH carrier switching via a radio resource control (RRC) message, for example, a pucchCarrierSwitching or pucchCellSwitching parameter. Of course, any other suitable ways are also feasible to transmit this configuration.

In some embodiments, the configuration regarding the PUCCH carrier switching may be specific to the terminal device 110. That is, the PUCCH carrier switching may be configured or enabled per UE. For example, the pucchCarrierSwitching or pucchCellSwitching parameter may be a UE specific RRC parameter. In this case, the PUCCH carrier switching can be enabled for the whole cell group 401 for the terminal device 110, i.e., for both the cell subgroups 411 and 421 in FIG. 4.

In some embodiments, the configuration regarding the PUCCH carrier switching may be associated with an identity (ID) of a PUCCH group, for example, ID of the cell subgroup 411 or 421. That is, the PUCCH carrier switching may be configured or enabled per PUCCH group of the terminal device 110. For example, the pucchCarrierSwitching or pucchCellSwitching parameter may be associated with a PUCCH group ID. In some embodiments, the configuration may be associated with a primary PUCCH group (for example, the cell subgroup 411) by default. In some embodiments, the configuration may be associated with a secondary PUCCH group (for example, the cell subgroup 421) by default.

In some embodiments, the source cell may be in the first subset of cells and the target cell may be in the second subset of cells. In other words, the PUCCH carrier switching may be configured or enabled across PUCCH groups. For example, as shown in FIG. 4, a PUCCH transmission for a HARQ feedback for a PDSCH received on CC #1 may be switched between the set of PUCCH cells 412 and the set of PUCCH cells 422. In some embodiments, the network device 120 may indicate which PUCCH cell of which PUCCH group is used for the PUCCH transmission, for example, by a dynamic indication, by a predefined rule, or by a RRC indication.

In some embodiments, the configuration regarding the PUCCH carrier switching may be associated with a priority of the first uplink control transmission. In other words, the PUCCH carrier switching may be configured or enabled per uplink control information (UCI) priority or PUCCH configuration of the terminal device 110. For example, the pucchCarrierSwitching or pucchCellSwitching parameter may be a priority specific RRC parameter. In some embodiments, only PUCCH for high priority HARQ-ACK can be switched between multiple PUCCH cells. In this way, the PUCCH carrier switching can be more flexibly enabled, for example, based on service requirements.

In some alternative or additional embodiments, the configuration regarding the PUCCH carrier switching may be associated with a scheduling of the first uplink control transmission. In other words, the PUCCH carrier switching may be configured or enabled for configured grant (CG) UCI and dynamically scheduled UCI separately. For example, the CG UCI may be a SPS HARQ-ACK. Of course, any other suitable ways for the CG UCI are also feasible. For example, the dynamically scheduled UCI may be a HARQ-ACK for dynamic grant (DG) PDSCH. Of course, any other suitable ways for the dynamically scheduled UCI are also feasible.

Return to FIG. 3A, upon receipt of the downlink transmission, the terminal device 110 determines 304 a cell (for convenience, also referred to as a second cell herein) for the uplink control transmission for the HARQ feedback for the downlink transmission. In some embodiments, the terminal device 110 may determine the second cell based on the configuration regarding the PUCCH carrier switching. For example, if the configuration indicates that the PUCCH carrier switching is enabled for the uplink control transmission, the terminal device 110 may perform the PUCCH carrier switching within the corresponding set of PUCCH cells as needed for determining the second cell. If the configuration indicates that the PUCCH carrier switching is disabled for the uplink control transmission, the terminal device 110 may determine the second cell without the PUCCH carrier switching.

In some embodiments where the PUCCH carrier switching is enabled, the terminal device 110 may determine the second cell based on DCI received from the network device 120. The DCI may comprise an indicator field indicating the second cell. In this way, a PUCCH cell for the PUCCH carrier switching can be dynamically indicated.

In some alternative embodiments where the PUCCH carrier switching is enabled, the terminal device 110 may determine the second cell based on a predetermined rule. In some embodiments, the terminal device 110 may determine the second cell from the set of PUCCH cells based on priorities of cells. For example, the terminal device 110 may determine whether a source cell with a first priority (for example, the highest priority) within the set of PUCCH cells is available for the uplink control transmission within a slot or sub-slot. If the source cell is unavailable, the terminal device 110 may determine, from the set of PUCCH cells, the second cell with a second priority which has enough valid symbols for the first uplink transmission within the slot or sub-slot, the second priority being lower than the first priority. It should be noted that the determination of the second cell may also be performed in any other suitable ways, and is not limited to the above examples.

Upon determination of the second cell, the terminal device 110 may perform 305 the uplink control transmission on the second cell.

### Example Implementation of Pucch Carrier Switching for Sps Harq-Ack

As known, for SPS downlink transmissions, the first SPS downlink transmission has activation DCI and subsequent SPS downlink transmissions have no corresponding DCI. As mentioned above, in some scenarios, the cell for PUCCH transmission for HARQ-ACK may be dynamically indicated by an indicator field in DCI, which means the PUCCH carrier can be dynamically switched between multiple cells for PUCCH by DCI indication. In this case, how to support a PUCCH carrier switching for the SPS downlink transmissions should be studied. In view of this, embodiments of the present disclosure provide solutions for supporting the PUCCH carrier switching for the SPS downlink transmissions. This will be described in Embodiments 1 and 2 in connection with FIG. 3B.

FIG. 3B illustrates a flow chart illustrating another process 300B of communication for HARQ feedback according to embodiments of the present disclosure. For the purpose of discussion, the process 300B will be described with reference to FIG. 1. The process 300B may involve the terminal device 110 and the network device 120 as illustrated in FIG. 1. Assuming that a downlink transmission (also referred to as a first downlink transmission herein) from the network device 120 is received by the terminal device 110 on a first cell.

### Embodiment 1

As shown in FIG. 3B, the network device 120 may determine 311 whether the downlink transmission is dynamically scheduled, semi-persistently scheduled, a retransmission of a SPS downlink data transmission or is for a release of a SPS configuration.

In some embodiments, if the downlink transmission is dynamically scheduled, the terminal device 110 may determine a second cell for an uplink control transmission for a HARQ feedback for the downlink transmission based on an indication in DCI received from the network device 120 for the downlink transmission, and perform 312 the uplink control transmission on the second cell.

In some embodiments, if the downlink transmission is semi-persistently scheduled, the terminal device 110 may cancel 313 the uplink control transmission for the HARQ feedback for the downlink transmission. That is, the PUCCH carrier switching for the HARQ feedback for the SPS downlink transmission is always not supported, regardless of the first SPS downlink transmission with activation DCI or subsequent SPS downlink transmissions without DCI. For example, when a PUCCH resource on Pcell for HARQ-ACK for SPS PDSCH collides with DL symbols/SSB symbols/CORESET 0, the terminal device 110 may drop the HARQ-ACK.

In some embodiments, if the downlink transmission is a retransmission of a SPS downlink data transmission or is for a release of a SPS configuration, the terminal device 110 may determine 314 the second cell based on the indication in the DCI, and perform 315 the uplink control transmission for the retransmission or the release on the second cell.

That is, the PUCCH carrier switching is supported for a HARQ feedback for the SPS downlink data transmission or the release of the SPS configuration. For example, when a PUCCH resource on Pcell for HARQ-ACK for SPS PDSCH Re-Tx or SPS release collides with DL symbols/SSB/CORESET 0, the terminal device 120 may transmit PUCCH for HARQ-ACK on the indicated cell by corresponding PDCCH.

In this way, the PUCCH carrier switching for SPS HARQ-ACK mechanism can be designed in a simple manner to improve the spectrum efficiency and reduce the latency when configured PUCCH for SPS HARQ-ACK is unavailable.

### Embodiment 2

This embodiment is an alternative for Embodiment 1. Still with reference to FIG. 3B, the terminal device 110 may determine 316 whether the downlink transmission is the first one of SPS downlink data transmissions, a retransmission of a SPS downlink data transmission or is for a release of a SPS configuration.

In some embodiments, if the downlink transmission is the first one of SPS downlink data transmissions, a retransmission of a SPS downlink data transmission or is for a release of a SPS configuration, the terminal device 110 may determine the second cell based on the indication in the DCI, and perform 317 the uplink control transmission for the first one of SPS downlink data transmissions, the retransmission or the release on the second cell.

That is, the PUCCH carrier switching is supported for a HARQ feedback for the first SPS downlink data transmission with activation DCI, the retransmission of a SPS downlink data transmission scheduled by DCI, and a downlink control transmission for the release of the SPS configuration. For example, when a PUCCH resource on Pcell for HARQ-ACK for the first SPS PDSCH with activation DCI or a SPS PDSCH retransmission or a SPS release collides with DL symbols/SSB/CORESET 0, the terminal device 120 may transmit PUCCH for HARQ-ACK on the indicated cell by corresponding PDCCH.

In some embodiments, if the downlink transmission is a SPS downlink data transmission without DCI, the terminal device 110 may cancel 318 the uplink control transmission for the SPS downlink data transmission without DCI. For example, when the corresponding PUCCH resource for SPS PDSCH only on the Pcell collides with DL symbols/SSB/CORESET 0, the terminal device 110 may drop the HARQ-ACK.

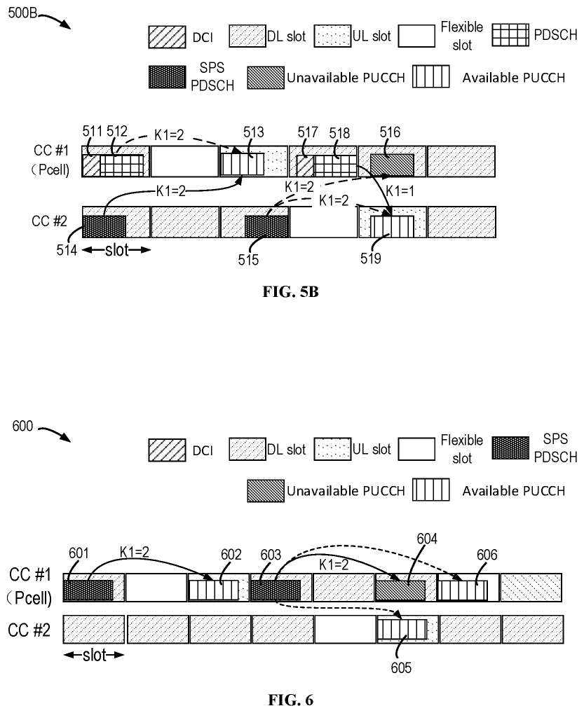

For clarity, some examples will be described in connection with FIG. 5A. FIG. 5A illustrates a schematic diagram 500A illustrating an example of a PUCCH carrier switching for SPS HARQ-ACK according to embodiments of the present disclosure. Assuming that the cell group comprises CC #1 as a Pcell and CC #2 as a Scell, and the set of PUCCH cells for the cell group comprises CC #1 and CC #2.

As shown in FIG. 5A, DCI 501 may indicate that a HARQ feedback for PDSCH 502 is transmitted by PUCCH 503 on CC #1, for example, with a HARQ-ACK timing value K1=2. SPS PDSCH 504 and SPS PDSCH 505 have no DCI. A HARQ feedback for SPS PDSCH 504 is configured to be transmitted by the PUCCH 503, for example, with a HARQ-ACK timing value K1=2. A HARQ feedback for SPS PDSCH 505 is configured to be transmitted by the PUCCH 506, for example, with a HARQ-ACK timing value K1=2. However, the PUCCH 506 will be in a DL slot and thus is unavailable. In this case, the terminal device 110 may drop the HARQ feedback for the SPS PDSCH 505.

In some embodiments where the downlink transmission is a SPS downlink data transmission without DCI, if the uplink control transmission (i.e., the first uplink control transmission) for the HARQ feedback (i.e., the first HARQ feedback) for the downlink transmission and a second uplink control transmission for a second HARQ feedback for a dynamic scheduled downlink data transmission are to be transmitted in the same slot, the terminal device 110 may multiplex 319 the first HARQ feedback onto the second uplink control transmission, and cancel 320 the first uplink control transmission. Then the terminal device 110 may perform 321 the second uplink control transmission with the first HARQ feedback multiplexed. For example, if HARQ-ACK for the SPS PDSCH and HARQ-ACK for DG PDSCH are in the same slot or sub-slot, the terminal device 110 may firstly multiplex the HARQ-ACK for SPS PDSCH and DG PDSCH in a same codebook as Release 16 and transmits the HARQ-ACK codebook on the PUCCH on the cell indicated by the scheduling DCI of DG PDSCH.

For clarity, some examples will be described in connection with FIG. 5B. FIG. 5B illustrates a schematic diagram 500B illustrating another example of a PUCCH carrier switching for SPS HARQ-ACK according to embodiments of the present disclosure. Assuming that the cell group comprises CC #1 as a Pcell and CC #2 as a Scell, and the set of PUCCH cells for the cell group comprises CC #1 and CC #2.

As shown in FIG. 5B, DCI 511 may indicate that a HARQ feedback for PDSCH 512 is transmitted by PUCCH 513 on CC #1, for example, with a HARQ-ACK timing value K1=2. SPS PDSCH 514 and SPS PDSCH 515 have no DCI. A HARQ feedback for SPS PDSCH 514 is configured to be transmitted by the PUCCH 513, for example, with a HARQ-ACK timing value K1=2. A HARQ feedback for SPS PDSCH 515 is configured to be transmitted by the PUCCH 516, for example, with a HARQ-ACK timing value K1=2. The PUCCH 516 will be in a DL slot and thus is unavailable. However, DCI 517 indicates that a HARQ feedback for PDSCH 518 on CC #1 is transmitted by PUCCH 519 on CC #2, for example, with a HARQ-ACK timing value K1=1. The PUCCH 516 and the PUCCH 519 are in the same slot. In this case, the terminal device 110 may multiplex the HARQ feedback for the SPS PDSCH 515 onto the PUCCH 519 and cancel the PUCCH 516.

Compared with Embodiment 1, the PUCCH carrier switching in this embodiment is complicated but more efficient.

### Example Implementation of Interaction Between Pucch Carrier Switching for SPS HARQ-ACK and SPS HARQ-ACK Deferral

As mentioned above, in some scenarios, the PUCCH cell for the PUCCH carrier switching may be determined based on the predetermined rule. In some other scenarios, a SPS HARQ-ACK deferral may be configured to delay a SPS HARQ-ACK to the next available PUCCH resource not overlapped with DL symbol if a PUCCH resource on Pcell for the SPS HARQ-ACK is unavailable. As a result, when the SPS HARQ-ACK deferral and the PUCCH carrier switching for HARQ-ACK are configured for the terminal device 110 simultaneously, the UE behavior to do the PUCCH carrier switching first or the SPS HARQ-ACK deferral first should be defined, otherwise, the terminal device 110 and the network device 120 may have different understanding on the SPS HARQ-ACK transmission, which will degrade the system performance. For clarity, it will be described in connection with FIG. 6.

FIG. 6 illustrates a schematic diagram 600 illustrating an example of an interaction between a PUCCH carrier switching for SPS HARQ-ACK and a SPS HARQ-ACK deferral according to embodiments of the present disclosure. Assuming that the cell group comprises CC #1 as a Pcell and CC #2 as a Scell, and the set of PUCCH cells for the cell group comprises CC #1 and CC #2. Also assuming that the SPS HARQ-ACK deferral and the PUCCH carrier switching for HARQ-ACK are configured for the terminal device 110 simultaneously.

As shown in FIG. 6, a HARQ feedback for SPS PDSCH 601 of SPS configuration #1 is configured to be transmitted by PUCCH 602, for example, with a HARQ-ACK timing value K1=2. A HARQ feedback for SPS PDSCH 603 of SPS configuration #1 is configured to be transmitted by PUCCH 604, for example, with a HARQ-ACK timing value K1=2. The PUCCH 604 will be in a DL slot and thus is unavailable. According to the SPS HARQ-ACK deferral, the HARQ feedback for the SPS PDSCH 603 will be delayed to be transmitted by PUCCH 606. However, according to the PUCCH carrier switching, the HARQ feedback for the SPS PDSCH 603 will be transmitted by PUCCH 605 on CC #2 within the same slot as the PUCCH 604. Thus, the UE behavior in this case should be defined so that the network device 120 can receive the HARQ-ACK from the terminal device 110 correctly. In view of this, embodiments of the present disclosure provide solutions for this scenario. It will be described in Embodiments 3 and 4 in connection with FIG. 3C.

FIG. 3C illustrates a flow chart illustrating another process 300C of communication for HARQ feedback according to embodiments of the present disclosure. For the purpose of discussion, the process 300C will be described with reference to FIG. 1. The process 300C may involve the terminal device 110 and the network device 120 as illustrated in FIG. 1. Assuming that a downlink transmission (also referred to as a first downlink transmission herein) from the network device 120 is received by the terminal device 110 on a first cell.

### Embodiment 3

In this embodiment, the PUCCH carrier switching for HARQ-ACK has priority over the SPS HARQ-ACK deferral. For example, if the PUCCH resource on Pcell for SPS HARQ-ACK is unavailable, the terminal device 110 may firstly determine another PUCCH cell for SPS HARQ-ACK transmission based on a predetermined rule for PUCCH carrier switching. If an available PUCCH resource can be found, the terminal device 110 will transmit the SPS HARQ-ACK on the PUCCH resource, otherwise, the terminal device 110 will delay the SPS HARQ-ACK on the next available PUCCH resource.

As shown in FIG. 3C, the terminal device 110 may determine 331 whether the downlink transmission is a SPS downlink data transmission. If the downlink transmission is the SPS downlink data transmission, the terminal device 110 may determine 332 whether an uplink control transmission within a slot or sub-slot on a source cell with a first priority is available, the uplink control transmission being for a HARQ feedback for the SPS downlink data transmission.

If the uplink control transmission on the source cell is unavailable, the terminal device 110 may determine 333 whether a target cell with a second priority presents in the set of PUCCH cells which has enough valid symbols for the uplink transmission within the slot or sub-slot, the first priority being higher than the second priority. If the target cell presents in the set of PUCCH cells, the terminal device 110 may determine the target cell as the second cell and perform 334 the uplink control transmission for the HARQ feedback for the SPS downlink data transmission on the second cell.

If the target cell does not present in the set of PUCCH cells, the terminal device 110 may delay 335 the uplink control transmission on the source cell. For example, with reference to FIG. 6, if the PUCCH 605 is available for the uplink control transmission, the HARQ-ACK for the SPS PDSCH 603 will be switched to be transmitted by the PUCCH 605 on CC #2. If the PUCCH 605 is unavailable for the uplink control transmission, the HARQ-ACK for the SPS PDSCH 603 will be delayed to be transmitted by the PUCCH 606. It is to be noted that this merely is an example, and does not make limitation to the present disclosure.

In this way, a lower latency can be achieved although PUCCH resource for SPS PDSCH may need to be configured on multiple cells.

### Embodiment 4

This embodiment is an alternative for Embodiment 3. In this embodiment, the SPS HARQ-ACK deferral has priority over the PUCCH carrier switching for HARQ-ACK. For example, when the SPS HARQ-ACK deferral is configured, the PUCCH carrier switching for SPS HARQ-ACK will be disabled. If the PUCCH resource on Pcell for SPS HARQ-ACK is unavailable, the terminal device 110 will delay the SPS HARQ-ACK on the next available PUCCH resource.

Still with reference to FIG. 3C, the terminal device 110 may determine 336 whether the uplink control transmission within a slot or sub-slot on a source cell with a first priority is available. If the uplink control transmission on the source cell is unavailable, the terminal device 110 may determine, from the set of PUCCH cells, the second cell with a second priority which has enough valid symbols for the uplink control transmission within the slot or sub-slot, the first priority being higher than the second priority. Then, the terminal device 110 may perform 337 the uplink control transmission over the second cell.

In some embodiments, the terminal device 110 may receive 338, from the network device 120, a configuration indicating that the SPS HARQ-ACK deferral is enabled. That is, the configuration indicates that a HARQ feedback for a SPS downlink data transmission on an uplink control transmission on a cell is enabled to be delayed when the uplink control transmission is unavailable on the cell.

Upon receipt of the configuration indicating that the SPS HARQ-ACK deferral is enabled, if the downlink transmission is the SPS downlink data transmission and the uplink control transmission on the source cell is unavailable, the terminal device 110 may delay 339 the uplink control transmission on the source cell. For example, with reference to FIG. 6, in case that PUCCH 604 is unavailable, the HARQ-ACK for the SPS PDSCH 603 will be directly delayed to be transmitted by the PUCCH 606.

In this way, a less impact is made on the 3GPP specification, and PUCCH resource for SPS PDSCH may be not configured on multiple cells.

### Example Implementation of Interaction Between Pucch Carrier Switching and Intra-UE Multiplexing

In some scenarios, a first PUCCH transmission may be overlapped with a second PUCCH transmission or PUSCH transmission in time domain. In this case, the overlapping may be solved by multiplexing or prioritizing the first PUCCH transmission and the second PUCCH transmission or PUSCH transmission. This operation is also referred to as intra-UE multiplexing herein.

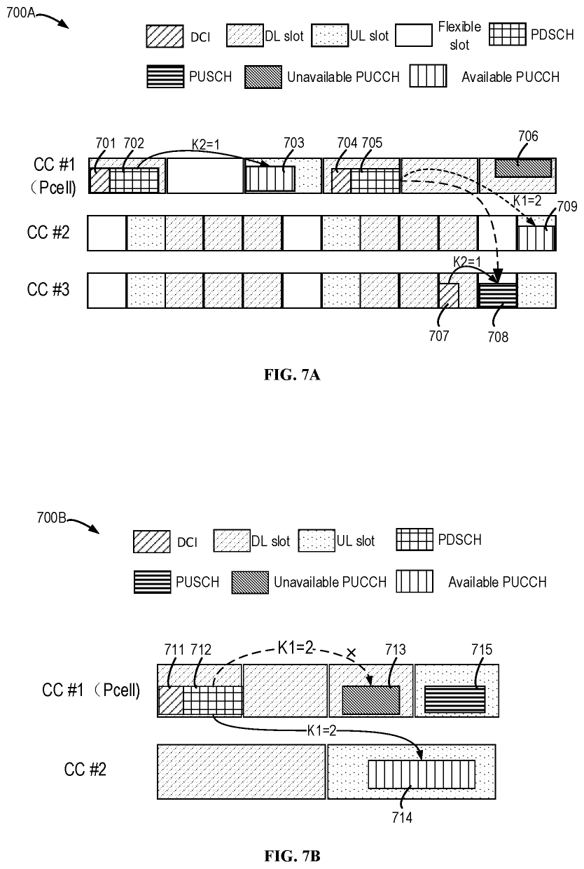

As mentioned above, in some scenarios, the PUCCH cell for the PUCCH carrier switching may be determined based on the predetermined rule. In this case, an overlapping between a switched PUCCH or original unavailable PUCCH and other PUSCH or PUCCH may occur in time domain. Considering this overlapping, an interaction between the intra-UE multiplexing and the PUCCH carrier switching needs to be determined so that the terminal device 110 and the network device 120 may have the same understanding on HARQ-ACK transmission. For clarity, it will be described in connection with FIG. 7A.

FIG. 7A illustrates a schematic diagram 700A illustrating an example for an interaction between a PUCCH carrier switching and an intra-UE multiplexing or prioritization according to embodiments of the present disclosure. Assuming that the cell group comprises CC #1 as a Pcell with 30 KHz, CC #2 as a Scell with 60 KHz and CC #3 as a Scell with 60 KHz, and the set of PUCCH cells for the cell group comprises CC #1 and CC #2.

As shown in FIG. 7A, DCI 701 may indicate that a HARQ feedback for PDSCH 702 is transmitted by PUCCH 703 on CC #1, for example, with a HARQ-ACK timing value K2=1. DCI 704 may indicate that a HARQ feedback for PDSCH 705 is transmitted by PUCCH 706 on CC #1, for example, with a HARQ-ACK timing value K2=1. However, PUCCH 706 is in a DL slot on CC #1, and thus is unavailable. According to the PUCCH carrier switching based on the predetermined rule, the HARQ-ACK for the PDSCH 705 can be switched to be transmitted by PUCCH 709 in the same slot on CC #2.

However, DCI 707 may schedule a PUSCH 708 on CC #3 with a scheduling offset K2=1. According to the intra-UE multiplexing, the HARQ-ACK for the PDSCH 705 may be multiplexed onto the PUSCH 708 and the PUCCH 706 is cancelled.

It can be seen that the intra-UE multiplexing and the PUCCH carrier switching may cause different transmission of the HARQ-ACK for the PDSCH 705. Thus, an interaction between the intra-UE multiplexing and the PUCCH carrier switching needs to be determined so that the terminal device 110 and the network device 120 may have the same understanding on HARQ-ACK transmission. In view of this, embodiments of the present disclosure provide solutions for this scenario. It will be described in Embodiments and 6 in connection with FIG. 3D.

FIG. 3D illustrates a flow chart illustrating another process 300D of communication for HARQ feedback according to embodiments of the present disclosure. For the purpose of discussion, the process 300D will be described with reference to FIG. 1. The process 300D may involve the terminal device 110 and the network device 120 as illustrated in FIG. 1. Assuming that a downlink transmission (also referred to as a first downlink transmission herein) from the network device 120 is received by the terminal device 110 on a first cell.

### Embodiment 5

In this embodiment, the intra-UE multiplexing has priority over the PUCCH carrier switching. In this case, multiple cells are configured for PUCCH transmission within a PUCCH group.

As shown in FIG. 3D, the terminal device 110 may determine 341, based on a predetermined rule, a source cell from the set of PUCCH cells for an uplink control transmission for a HARQ feedback for the downlink transmission. For example, the terminal device 110 may firstly determine, as the source cell, a PUCCH resource on Pcell for HARQ-ACK transmission within a slot indicated by k1 value.

The terminal device 110 may determine 342 whether the uplink control transmission on the source cell is overlapped with an uplink transmission (for example, a PUCCH or PUSCH) in time domain. If the uplink control transmission is overlapped with the uplink transmission, the terminal device 110 may generate 343 a final uplink transmission by multiplexing or prioritizing the uplink control transmission and the uplink transmission. For example, the terminal device 110 may do the intra-UE multiplexing if there is another PUCCH/PUSCH overlapped with the PUCCH, and obtain a final PUCCH/PUSCH.

If the final uplink transmission is unavailable, the terminal device 110 may determine 344 whether the uplink control transmission on the source cell is available. If the uplink control transmission on the source cell is available, the terminal device 110 may perform 345 the uplink control transmission on the source cell. If the uplink control transmission on the source cell is unavailable, the terminal device 110 may determine 346 a second cell with a second priority which has enough valid symbols for the uplink control transmission within the slot or sub-slot, the first priority being higher than the second priority. For example, if the final PUCCH/PUSCH collides with DL symbols/SSB symbols/CORESET #0, the terminal device 110 may determine an available PUCCH with enough UL OFDM symbol for HARQ-ACK transmission on a PUCCH cell based on the predefined cell selection order.

Then the terminal device 110 may perform 347 the uplink control transmission on the second cell. That is, the PUCCH carrier switching is selectively performed after the intra-UE multiplexing. With reference to FIG. 7A, the HARQ-ACK for the PDSCH 705 will be multiplexed onto the PUSCH 708 and will be transmitted to the network device 120 by the PUSCH 708.

In some embodiments, if the uplink control transmission on the second cell is overlapped with another uplink transmission, the terminal device 110 may consider that an error occurs. In other words, the terminal device 110 does not expect the determined switched PUCCH for HARQ-ACK to be overlapped with another PUCCH and/or PUSCH.

For clarity, it will be detailed in connection with FIG. 7B. FIG. 7B illustrates a schematic diagram 700B illustrating an example scenario of the interaction between the PUCCH carrier switching and the intra-UE multiplexing according to embodiments of the present disclosure.

With reference to FIG. 7B, DCI 711 may indicate that a HARQ feedback for PDSCH 712 is transmitted by PUCCH 713 on CC #1, for example, with a HARQ-ACK timing value K1=2. However, PUCCH 713 is in a DL slot on CC #1, and thus is unavailable. According to the PUCCH carrier switching based on the predetermined rule, the HARQ-ACK for the PDSCH 712 can be switched to be transmitted by PUCCH 714 in the same slot on CC #2. However, the PUCCH 714 will be overlapped with PUSCH 715 on CC #1 within the same slot. The terminal device 110 does not expect that this situation occurs and considers that this situation is an error.

### Embodiment 6

This embodiment is an alternative for Embodiment 5. In this embodiment, the PUCCH carrier switching has priority over the intra-UE multiplexing. In this case, multiple cells are also configured for PUCCH transmission within a PUCCH group.

Still with reference to FIG. 3D, upon receipt of the downlink transmission on the first cell, the terminal device 110 may determine 348, based on a predetermined rule, a source cell from the set of PUCCH cells for an uplink control transmission for a HARQ feedback for the downlink transmission. For example, the terminal device 110 may firstly determine, as the source cell, a PUCCH resource on Pcell for HARQ-ACK transmission within a slot indicated by k1 value.

Then the terminal device 110 may determine 349 whether the uplink control transmission on the source cell with a first priority is available. If the uplink control transmission on the source cell is unavailable, the terminal device 110 may determine 350, from the set of PUCCH cells, a second cell with a second priority which has enough valid symbols for the uplink control transmission within the slot or sub-slot, the first priority being higher than the second priority. For example, the terminal device 110 may determine whether the PUCCH collides with DL symbols/SSB symbols/CORESET #0, and if the PUCCH collides with DL symbols/SSB symbols/CORESET #0, the terminal device 110 will determine an available PUCCH (i.e., switched PUCCH) with enough UL OFDM symbol for HARQ-ACK transmission on a cell based on the predefined cell selection order.

The terminal device 110 may determine 351 whether the uplink control transmission on the second cell is overlapped with an uplink transmission (for example, a PUCCH or PUSCH) in time domain. If the uplink control transmission is overlapped with an uplink data transmission, the terminal device 110 may multiplex 352 the HARQ feedback for the downlink transmission onto the uplink data transmission, and cancel 353 the uplink control transmission. The terminal device 110 may perform 354 the uplink data transmission with the HARQ feedback multiplexed.

If the uplink control transmission on the second cell is overlapped with another uplink control transmission (for convenience, also referred to as a third uplink control transmission herein) with uplink control information in time domain, the terminal device 110 may determine 355 that an error occurs. That is, the terminal device 110 does not expect this case to happen.

In some alternative embodiments, if the uplink control transmission on the second cell is overlapped with the third uplink control transmission with the uplink control information in time domain, the terminal device 110 may perform 356 the uplink control transmission while cancelling the third uplink control transmission. That is, the terminal device 110 may only transmit the switched PUCCH and drops UCI on the other PUCCH.

In some alternative embodiments, if the uplink control transmission on the second cell is overlapped with the third uplink control transmission with the uplink control information in time domain, the terminal device 110 may perform 357 the uplink control transmission and the third uplink control transmission simultaneously. That is, the terminal device 110 simultaneously transmits two PUCCHs.

In some alternative embodiments, if the uplink control transmission on the second cell is overlapped with the third uplink control transmission with the uplink control information in time domain, the terminal device 110 may multiplex 358 the uplink control information on the first uplink control transmission while cancelling the third uplink control transmission. That is, the terminal device 120 may multiplex all UCI onto the switched PUCCH and cancel the other PUCCH.

In this way, a clear rule is defined for the order of intra-UE multiplexing and PUCCH carrier switching for HARQ-ACK to ensure the alignment between the network device 120 and the terminal device 110 on HARQ-ACK transmission.

### Example Implementation of Methods

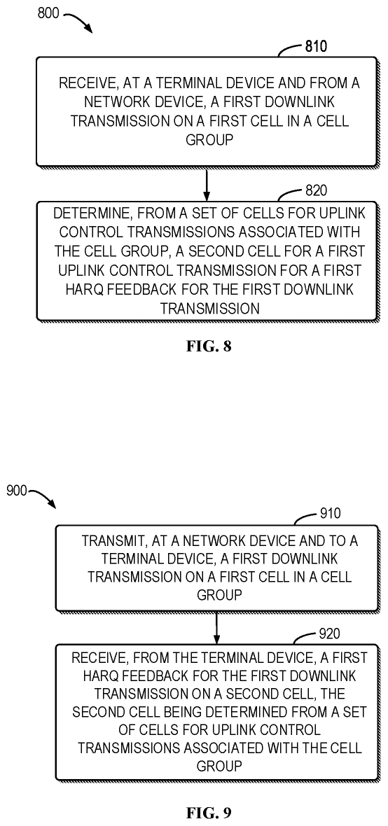

Accordingly, embodiments of the present disclosure provide methods of communication implemented at a terminal device and a network device. These methods will be described below with reference to FIGS. 8 to 10.

FIG. 8 illustrates an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the terminal device 110 receives from the network device 120, a first downlink transmission on a first cell in a cell group. In some embodiments, the first downlink transmission may be a downlink data transmission. In some embodiments, the first downlink transmission may be a downlink control transmission.

At block 820, the terminal device 110 determines, from a set of cells for uplink control transmissions associated with the cell group, a second cell for a first uplink control transmission for a first HARQ feedback for the first downlink transmission. In some embodiments, the terminal device 110 may receive, from the network device 120, a configuration indicating that the first uplink control transmission is enabled to change from being performed on a source cell in the set of cells to being performed on a target cell in the set of cells, and determine the second cell based on the configuration.

In some embodiments, the configuration is specific to the terminal device 110. In some embodiments where the cell group comprises a first subgroup of cells and a second subgroup of cells, and the set of cells comprises a first subset of cells associated with the first subgroup of cells and a second subset of cells associated with the second subgroup of cells, and wherein the first cell is in the first subgroup, the configuration is associated with an identity of the first subgroup.

In some embodiments where the cell group comprises a first subgroup of cells and a second subgroup of cells, and the set of cells comprises a first subset of cells associated with the first subgroup of cells and a second subset of cells associated with the second subgroup of cells, and wherein the first cell is in the first subgroup, the source cell is in the first subset of cells and the target cell is in the second subset of cells.

In some embodiments, the configuration is associated with at least one of a priority or a scheduling of the first uplink control transmission. In this way, enabling or disabling of PUCCH carrier switching can be achieved.

In some embodiments, if the first downlink transmission is dynamically scheduled, the terminal device 110 may determine the second cell based on an indication in downlink control information received from the network device for the first downlink transmission. In some embodiments, if the first downlink transmission is semi-persistently scheduled, the terminal device 110 may cancel the first uplink control transmission. In some embodiments, if the first downlink transmission is a retransmission of a semi-persistently scheduled downlink data transmission or is for a release of a semi-persistent scheduling configuration, the terminal device 110 may determine the second cell based on the indication in the downlink control information. In this way, a PUCCH carrier switching for SPS HARQ-ACK can be achieved in a simple way.

In some embodiments, if the first downlink transmission is for at least one of the following, the terminal device 110 may determine the second cell based on the indication in the downlink control information: the first one of semi-persistently scheduled downlink data transmissions, a retransmission of a semi-persistently scheduled downlink data transmission, or a release of a semi-persistent scheduling configuration. In some embodiments, if the first downlink transmission is a semi-persistently scheduled downlink data transmission without downlink control information, the terminal device 110 may cancel the first uplink control transmission.

In some embodiments, if the first downlink transmission is a semi-persistently scheduled downlink data transmission without downlink control information and that the first uplink control transmission and a second uplink control transmission are to be transmitted in the same slot, the second uplink control transmission being for a second HARQ feedback for a dynamic scheduled downlink data transmission, the terminal device 110 may multiplex the first HARQ feedback onto the second uplink control transmission and cancel the first uplink control transmission. In this way, a PUCCH carrier switching for SPS HARQ-ACK can be achieved in an effective way.

In some embodiments, the terminal device 110 may receive, from the network device 120, a configuration indicating that a HARQ feedback for a semi-persistently scheduled downlink data transmission on an uplink control transmission on a cell is enabled to be delayed when the uplink control transmission is unavailable on the cell. In these embodiments, if the first downlink transmission is a semi-persistently scheduled downlink data transmission, the terminal device 110 may determine whether the first uplink control transmission within a slot or sub-slot on a source cell with a first priority is available. If the first uplink control transmission on the source cell is unavailable, the terminal device 110 may determine whether a target cell with a second priority presents in the set of cells which has enough valid symbols for the first uplink transmission within the slot or sub-slot, the first priority being higher than the second priority. If the target cell presents in the set of cells, the terminal device 110 may determine the target cell as the second cell. If the target cell does not present in the set of cells, the terminal device 110 may delay the first uplink control transmission on the source cell. In this way, an interaction between a PUCCH carrier switching for SPS HARQ-ACK and a SPS HARQ-ACK deferral can be defined, i.e., the PUCCH carrier switching for SPS HARQ-ACK has priority over the SPS HARQ-ACK deferral.

In some alternative embodiments, the terminal device 110 may determine whether the first uplink control transmission within a slot or sub-slot on a source cell with a first priority is available. If the first uplink control transmission on the source cell is unavailable, the terminal device 110 may determine, from the set of cells, the second cell with a second priority which has enough valid symbols for the first uplink control transmission within the slot or sub-slot, the first priority being higher than the second priority. If the first downlink transmission is the semi-persistently scheduled downlink data transmission and the first uplink control transmission on the source cell is unavailable, the terminal device 110 may delay the first uplink control transmission on the source cell. In this way, an interaction between a PUCCH carrier switching for SPS HARQ-ACK and a SPS HARQ-ACK deferral can also be defined i.e., the SPS HARQ-ACK deferral has priority over the PUCCH carrier switching for SPS HARQ-ACK.

In some embodiments, if the first uplink control transmission on the source cell is overlapped with an uplink transmission in time domain, the terminal device 110 may generate a final uplink transmission by multiplexing or prioritizing the first uplink control transmission and the uplink transmission. If the final uplink transmission is unavailable, the terminal device 110 may determine whether the first uplink control transmission on the source cell is available. If the first uplink control transmission on the source cell is unavailable, the terminal device 110 may determine, from the set of cells, the second cell with a second priority which has enough valid symbols for the first uplink control transmission within the slot or sub-slot, the first priority being higher than the second priority. Then, the first uplink control transmission can be performed on the second cell. In this way, an interaction between a PUCCH carrier switching for HARQ-ACK and an intra-UE multiplexing can also be defined i.e., the intra-UE multiplexing has priority over the PUCCH carrier switching for HARQ-ACK.

In some alternative embodiments, if the first uplink control transmission on the second cell is overlapped with an uplink data transmission in time domain, the terminal device 110 may multiplex the first HARQ feedback onto the uplink data transmission, and cancel the first uplink control transmission. In some embodiments, if the first uplink control transmission on the second cell is overlapped with a third uplink control transmission with uplink control information in time domain, the terminal device 110 may perform one of the following: determining that an error occurs; performing the first uplink control transmission while cancelling the third uplink control transmission; performing the first uplink control transmission and the third uplink control transmission simultaneously; or multiplexing the uplink control information on the first uplink control transmission while cancelling the third uplink control transmission.

In this way, an interaction between a PUCCH carrier switching for HARQ-ACK and an intra-UE multiplexing can also be defined i.e., the PUCCH carrier switching for HARQ-ACK has priority over the intra-UE multiplexing.

FIG. 9 illustrates an example method 900 of communication implemented at a network device in accordance with some embodiments of the present disclosure. For example, the method 900 may be performed at the network device 120 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

As shown in FIG. 9, at block 910, the network device 120 transmits, to the terminal device 110, a first downlink transmission on a first cell in a cell group. In some embodiments, the network device 120 may transmit to the terminal device 110, a configuration indicating that the first uplink control transmission is enabled to change from being performed on a source cell in the set of cells to being performed on a target cell in the set of cells.

In some embodiments, the configuration is specific to the terminal device 110. In some embodiments where the cell group comprises a first subgroup of cells and a second subgroup of cells, and the set of cells comprises a first subset of cells associated with the first subgroup of cells and a second subset of cells associated with the second subgroup of cells, and wherein the first cell is in the first subgroup, the configuration is associated with an identity of the first subgroup.

In some embodiments where the cell group comprises a first subgroup of cells and a second subgroup of cells, and the set of cells comprises a first subset of cells associated with the first subgroup of cells and a second subset of cells associated with the second subgroup of cells, and wherein the first cell is in the first subgroup, the source cell is in the first subset of cells and the target cell is in the second subset of cells.

In some embodiments, the configuration is associated with at least one of a priority or a scheduling of the first uplink control transmission. In this way, a PUCCH carrier switching can be enabled or disabled.

At block 920, the network device 120 receives, from the terminal device 110, a first HARQ feedback for the first downlink transmission on a second cell, the second cell being determined from a set of cells for uplink control transmissions associated with the cell group. In some embodiments where the first downlink transmission is a semi-persistently scheduled downlink data transmission without downlink control information, the network device 120 may receive, from the terminal device 110, a second uplink control transmission with the first HARQ feedback multiplexed, the second uplink control transmission being for a second HARQ feedback for a dynamic scheduled downlink data transmission, and obtain the first HARQ feedback from the second uplink control transmission.

In some embodiments, the network device 120 may transmit, to the terminal device 110, a configuration indicating that a HARQ feedback for a semi-persistently scheduled downlink data transmission on an uplink control transmission on a cell is enabled to be delayed when the uplink control transmission is unavailable on the cell. In some embodiments, the network device 120 may receive the first HARQ feedback by at least one of the following: receiving, from the terminal device 110, the first uplink control transmission and a third uplink control transmission with uplink control information simultaneously; or receiving, from the terminal device 110, the first uplink control transmission with the uplink control information multiplexed.

### Example Implementation of Device

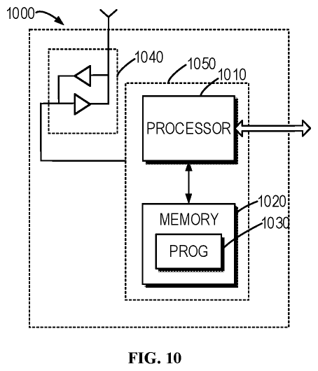

FIG. 10 is a simplified block diagram of a device 1000 that is suitable for implementing embodiments of the present disclosure. The device 1000 can be considered as a further example implementation of the terminal device 110 or the network device 120 as shown in FIG. 1. Accordingly, the device 1000 can be implemented at or as at least a part of the terminal device 110 or the network device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones.

The communication interface may represent any interface that is necessary for communication with other network elements, such as X2/Xn interface for bidirectional communications between eNBs/gNBs, Sl/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 3A to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises circuitry configured to: receive, from a network device, a first downlink transmission on a first cell in a cell group; and determine, from a set of cells for uplink control transmissions associated with the cell group, a second cell for a first uplink control transmission for a first HARQ feedback for the first downlink transmission.

In some embodiments, the circuitry may be configured to determine the second cell by: receiving, from the network device, a configuration indicating that the first uplink control transmission is enabled to change from being performed on a source cell in the set of cells to being performed on a target cell in the set of cells; and determining the second cell based on the configuration.

In some embodiments, the configuration is specific to the terminal device. In some embodiments where the cell group comprises a first subgroup of cells and a second subgroup of cells, and the set of cells comprises a first subset of cells associated with the first subgroup of cells and a second subset of cells associated with the second subgroup of cells, and where the first cell is in the first subgroup, the configuration is associated with an identity of the first subgroup.

In some embodiments where the cell group comprises a first subgroup of cells and a second subgroup of cells, and the set of cells comprises a first subset of cells associated with the first subgroup of cells and a second subset of cells associated with the second subgroup of cells, and where the first cell is in the first subgroup, the source cell is in the first subset of cells and the target cell is in the second subset of cells.

In some embodiments, the configuration is associated with at least one of a priority or a scheduling of the first uplink control transmission.

In some embodiments, the circuitry may be configured to determine the second cell by: in accordance with a determination that the first downlink transmission is dynamically scheduled, determining the second cell based on an indication in downlink control information received from the network device for the first downlink transmission. In some embodiments, the circuitry may be further configured to cancel the first uplink control transmission in accordance with a determination that the first downlink transmission is semi-persistently scheduled.

In some embodiments, the circuitry may be configured to determine the second cell by: in accordance with a determination that the first downlink transmission is a retransmission of a semi-persistently scheduled downlink data transmission or is for a release of a semi-persistent scheduling configuration, determining the second cell based on the indication in the downlink control information.

In some embodiments, the circuitry may be configured to determine the second cell by: in accordance with a determination that the first downlink transmission is for at least one of the following, determining the second cell based on the indication in the downlink control information: the first one of semi-persistently scheduled downlink data transmissions, a retransmission of a semi-persistently scheduled downlink data transmission, or a release of a semi-persistent scheduling configuration. In some embodiments, the circuitry may be further configured to cancel the first uplink control transmission in accordance with a determination that the first downlink transmission is a semi-persistently scheduled downlink data transmission without downlink control information.

In some embodiments where the first downlink transmission is a semi-persistently scheduled downlink data transmission without downlink control information and that the first uplink control transmission and a second uplink control transmission are to be transmitted in the same slot, the second uplink control transmission being for a second HARQ feedback for a dynamic scheduled downlink data transmission, the circuitry may be further configured to multiplex the first HARQ feedback onto the second uplink control transmission and cancel the first uplink control transmission.

In some embodiments, the circuitry may be configured to determine the second cell by: in accordance with a determination that the first downlink transmission is a semi-persistently scheduled downlink data transmission, determining whether the first uplink control transmission within a slot or sub-slot on a source cell with a first priority is available; in accordance with a determination that the first uplink control transmission on the source cell is unavailable, determining whether a target cell with a second priority presents in the set of cells which has enough valid symbols for the first uplink transmission within the slot or sub-slot, the first priority being higher than the second priority; and in accordance with a determination that the target cell presents in the set of cells, determining the target cell as the second cell.

In some embodiments, the circuitry may be further configured to delay the first uplink control transmission on the source cell in accordance with a determination that the target cell does not present in the set of cells.

In some embodiments, the circuitry may be configured to determine the second cell by: determining whether the first uplink control transmission within a slot or sub-slot on a source cell with a first priority is available; and in accordance with a determination that the first uplink control transmission on the source cell is unavailable, determining, from the set of cells, the second cell with a second priority which has enough valid symbols for the first uplink control transmission within the slot or sub-slot, the first priority being higher than the second priority.

In some embodiments, the circuitry may be further configured to: receive, from the network device, a configuration indicating that a HARQ feedback for a semi-persistently scheduled downlink data transmission on an uplink control transmission on a cell is enabled to be delayed when the uplink control transmission is unavailable on the cell; and in accordance with a determination that the first downlink transmission is the semi-persistently scheduled downlink data transmission and the first uplink control transmission on the source cell is unavailable, delay the first uplink control transmission on the source cell.

In some embodiments, the circuitry may be configured to determine whether the first uplink control transmission on the source cell is available by: in accordance with a determination that the first uplink control transmission on the source cell is overlapped with an uplink transmission in time domain, generating a final uplink transmission by multiplexing or prioritizing the first uplink control transmission and the uplink transmission; and in accordance with a determination that the final uplink transmission is unavailable, determining whether the first uplink control transmission on the source cell is available.

In some embodiments where the first uplink control transmission on the second cell is overlapped with an uplink data transmission in time domain, the circuitry may be further configured to multiplex the first HARQ feedback onto the uplink data transmission and cancel the first uplink control transmission.

In some embodiments where the first uplink control transmission on the second cell is overlapped with a third uplink control transmission with uplink control information in time domain, the circuitry may be further configured to perform one of the following: determining that an error occurs; performing the first uplink control transmission while cancelling the third uplink control transmission; performing the first uplink control transmission and the third uplink control transmission simultaneously; or multiplexing the uplink control information on the first uplink control transmission while cancelling the third uplink control transmission.

In some embodiments, a network device comprises circuitry configured to: transmit, at a network device and to a terminal device, a first downlink transmission on a first cell in a cell group; and receive, from the terminal device, a first HARQ feedback for the first downlink transmission on a second cell, the second cell being determined from a set of cells for uplink control transmissions associated with the cell group.

In some embodiments, the circuitry may be further configured to transmit, to the terminal device, a configuration indicating that the first uplink control transmission is enabled to change from being performed on a source cell in the set of cells to being performed on a target cell in the set of cells.

In some embodiments, the configuration is specific to the terminal device. In some embodiments where the cell group comprises a first subgroup of cells and a second subgroup of cells, the set of cells comprises a first subset of cells associated with the first subgroup of cells and a second subset of cells associated with the second subgroup of cells, and the first cell is in the first subgroup, the configuration is associated with an identity of the first subgroup.

In some embodiments where the cell group comprises a first subgroup of cells and a second subgroup of cells, the set of cells comprises a first subset of cells associated with the first subgroup of cells and a second subset of cells associated with the second subgroup of cells, and the first cell is in the first subgroup, the source cell is in the first subset of cells and the target cell is in the second subset of cells.

In some embodiments, the configuration is associated with at least one of a priority or a scheduling of the first uplink control transmission.

In some embodiments where the first downlink transmission is a semi-persistently scheduled downlink data transmission without downlink control information, the circuitry may be configured to receive the first HARQ feedback by receiving, from the terminal device, a second uplink control transmission with the first HARQ feedback multiplexed, the second uplink control transmission being for a second HARQ feedback for a dynamic scheduled downlink data transmission; and obtaining the first HARQ feedback from the second uplink control transmission.

In some embodiments, the circuitry may be further configured to transmit, to the terminal device, a configuration indicating that a HARQ feedback for a semi-persistently scheduled downlink data transmission on an uplink control transmission on a cell is enabled to be delayed when the uplink control transmission is unavailable on the cell.

In some embodiments, the circuitry may be configured to receive the first HARQ feedback by at least one of the following: receiving, from the terminal device, the first uplink control transmission and a third uplink control transmission with uplink control information simultaneously; or receiving, from the terminal device, the first uplink control transmission with the uplink control information multiplexed.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3A to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-31. (canceled)

32. A method of a User Equipment (UE), comprising:
receiving a Radio resource control (RRC) message comprising first information of a plurality of Physical Uplink Control Channel (PUCCH) cells, wherein the first information is for PUCCH cell switching, and
determining a cell based on the first information for PUCCH transmission.

33. The method of claim 32, further comprising:
receiving Downlink control information (DCI) comprising an indicator indicating a cell for second PUCCH transmission, and
transmitting a PUCCH on a Secondary Cell (SCell) indicated by the indicator in the DCI.

34. The method of claim 32, wherein:
The cell is either a Primary Cell (PCell) or a Secondary Cell (SCell) for a PUCCH.

35. The method of claim 32, wherein:
The cell is determined based on the first information, in a case where the UE receives a second information for deferring Hybrid Automatic Repeat Request-Acknowledge (HARQ-ACK) for Semi-persistent Scheduling (SPS) Physical downlink shared channel (PDSCH).

36. A User Equipment (UE), comprising:
a memory storing instructions; and
a processor configured to execute the instructions to:
receive a Radio resource control (RRC) message comprising first information of a plurality of Physical Uplink Control Channel (PUCCH) cells, wherein the first information is for PUCCH cell switching, and
determine a cell based on the first information for PUCCH transmission.

37. The UE of claim 36, further comprising:
The UE receives Downlink control information (DCI) comprising an indicator indicating a cell for second PUCCH transmission, and
transmits a PUCCH on a Secondary Cell (SCell) indicated by the indicator in the DCI.

38. The UE of claim 36, wherein
The cell is either a Primary Cell (PCell) or a Secondary Cell (SCell) for a PUCCH.

39. The UE of claim 36, wherein:
The cell is determined based on the first information, in a case where the UE receives a second information for deferring Hybrid Automatic Repeat Request-Acknowledge (HARQ-ACK) for Semi-persistent Scheduling (SPS) Physical downlink shared channel (PDSCH).
